(19) United States
(12) Patent Application Publication
(10) Pub. No.: US 2017/0277247 A1
(43) Pub. Date: Sep. 28, 2017

(54) AUTOMATIC CONTROL DEVICE AND METHOD FOR INTELLIGENT BACKUP POWER SOURCE

(71) Applicant: Yu-Jui Hsu, New Taipei City (TW)

(72) Inventor: Yu-Jui Hsu, New Taipei City (TW)

(21) Appl. No.: 15/079,055

(22) Filed: Mar. 24, 2016

(51) Int. Cl. G06F 1/32

(52) U.S. Cl. CPC G06F 1/3287

(57) ABSTRACT

An automatic control device and method for intelligent backup power source includes: a system main body; a primary power source, connected to the system main body; a work item presetting device, programmed with a plurality of preset work items and installed with a timer for arranging the operating time thereof; a determining device, served to determine and ensure whether the primary power source operates normally; a backup power source; a switching device, served to switch to the electric power provided by the backup power source with respect to the primary power source for being supplied to the system main body; and a timer actuating device, served to process the plural preset work items. Accordingly, the backup power source can be used for allowing the system main body to be provided with the uninterrupted power supply, and the corresponding preset work items are enabled to be processed.

### BACKGROUND OF THE INVENTION

1. Field of the Invention

The present invention relates to an automatic control device and method, especially to an automatic control device and method for intelligent backup power source, in which a work item presetting device connected to a system main body and having a timer is used for presetting preset work items, so when a primary power source is unable to supply electric power, a switching device is able to serve to switch to a backup power source, and a timer actuating device is actuated and the preset work items are enabled to be automatically processed.

2. Description of Related Art

A general electronic product needs its own primary power source for supplying electric power for the purpose of operation, if the primary power source is in a malfunction status, the electric power cannot be normally supplied, so the electronic product which had operated normally would shut off and all operations would be terminated, the main reason is that the electronic product is not additionally installed with a backup power source for supplying electric power, some users may prepare a backup power source, but the backup power source is unable to directly supply the electric power to the electronic product with an uninterrupted manner, so a situation of temporally power blackout and no preparation of the above-mentioned backup power source would be caused; moreover, the skipped people in the art have developed an uninterruptable power supply (UPS), when the uninterruptable power supply is actuated, the uninterruptable power supply would firstly determine whether the primary power source is able to supply electric power, if the primary power source is unable to supply electric power, the backup power source is switched on with an uninterrupted manner, if the primary power source operates normally, the uninterruptable power supply (UPS) would be in a DO NOTHING status; furthermore, because the structure of the uninterruptable power supply (UPS) is not installed with a work item presetting device capable of presetting a plurality of preset work items, and not installed with a timer actuating device for automatically processing the plural preset work items, for example: transmitting warning signals while sequentially and automatically processing storing the videos currently in filming, and normal turn on procedures, so the practicability thereof is very much limited. Thus, the above-mentioned disadvantages shall be serious concerned by consumers and the skilled people in the art. Accordingly, the applicant of the present invention has devoted himself for developing an automatic control device and method for intelligent backup power source, in which a work item presetting device having a timer and capable of presetting preset work items being able to be connected to a system main body, so when a primary power source is unable to supply electric power, a switching device can be utilized for switching to a backup power source, and a timer actuating device is actuated and the preset work items are enabled to be automatically processed; moreover, the backup power source is able to assist the system main body for achieving an objective of having uninterrupted power source, and the corresponding preset work items can be processed; thus, an automatic control device for intelligent backup power source having the operation convenience and safety being greatly improved is provided.

### SUMMARY OF THE INVENTION

For solving the above-mentioned shortages and disadvantages, one primary objective of the present invention is to provide an automatic control device and method for intelligent backup power source, in which a work item presetting device connected to a system main body and having a timer is used for presetting preset work items, so when a primary power source is unable to supply electric power, a switching device is able to serve to switch to a backup power source, and a timer actuating device is actuated and the preset work items are enabled to be automatically processed, thereby overcoming the shortages and disadvantages existed in prior art.

Another objective of the present invention is to provide an automatic control device and method for intelligent backup power source, in which a backup power source is used for allowing a system main body to be provided with an uninterrupted power supply, and corresponding preset work items are enabled to be processed.

The problem to be solved by the present invention is that: a general electronic product needs its own primary power source for supplying electric power for the purpose of operation, if the primary power source is in a malfunction status, the electric power cannot be normally supplied, so the electronic product which had operated normally would shut off and all operations would be terminated, the main reason is that the electronic product is not additionally installed with a backup power source for supplying electric power, some users may prepare a backup power source, but the backup power source is unable to directly supply the electric power to the electronic product with an uninterrupted manner, so a situation of temporally power blackout and no preparation of the above-mentioned backup power source would be caused; moreover, the skipped people in the art have developed an uninterruptable power supply (UPS), when the uninterruptable power supply is actuated, the uninterruptable power supply would firstly determine whether the primary power source is able to supply electric power, if the primary power source is unable to supply electric power, the backup power source is switched on with an uninterrupted manner, if the primary power source operates normally, the uninterruptable power supply (UPS) would be in a DO NOTHING status; furthermore, because the structure of the uninterruptable power supply (UPS) is not installed with a work item presetting device capable of presetting a plurality of preset work items, and not installed with a timer actuating device for automatically processing the plural preset work items, for example: transmitting warning signals while sequentially and automatically processing storing the videos currently in filming, and normal turn on procedures, so the practicability thereof is very much limited.

Accordingly, the present invention provides an automatic control device for intelligent backup power source, which is applied in an electronic product and includes:

a system main body, connected to the electronic device;

a primary power source, connected to the system main body and served to supply electric power;

a work item presetting device, connected to the system main body and programmed with a plurality of preset work items, wherein the work item presetting device is installed with a timer for arranging the operating time of the plural preset work items;

a determining device, connected to the system main body and served to determine and ensure whether the primary power source operates normally;

a backup power source, connected to the system main body and the determining device;

a switching device, connected to the system main body and the backup power source, and served to switch to the electric power provided by the backup power source with respect to the primary power source for being supplied to the system main body; and

a timer actuating device, connected to the system main body, the backup power source and the timer of the work item presetting device, and served to process the plural preset work items having the operating time thereof being arranged by the work item presetting device.

Preferably, according to the present invention, the backup power source is built-in in the system main body or externally connected to the system main body.

Preferably, according to the present invention, the preset work items of the work item presetting device include: calculating, managing power, transferring data, receiving data, storing data, operating, turning on, shutting off, transmitting information, receiving information, managing system, controlling system and monitoring system status.

Preferably, according to the present invention, the preset work items and the operating time thereof are processed in sequence with respect to the settings.

Preferably, according to the present invention, when the switching device switches to the backup power source then the primary power source is connected to the system main body, the timer actuating device and the preset work items are not actuated nor processed.

Accordingly, the present invention provides an automatic control method for intelligent backup power source, which includes the steps of:

connecting a primary power source to a system main body;

turning on the system main body and actuating a backup power source connected to the system main body;

utilizing a work item presetting device connected to the system main body and having a timer for setting preset work items;

connecting a determining device to the system main body, and utilizing the determining device for determining and ensuring whether the primary power source operates normally; if the primary power source is determined to be in a normal operating status, then a DO NOTHING status is formed; if the primary power source does not operate, then the switching device is utilized for switching to the backup power source; and

actuating a timer actuating device and automatically processing and arranging the preset work items.

Preferably, according to the present invention, the preset work items include: calculating, managing power, transferring data, receiving data, storing data, operating, turning on, shutting off, transmitting information, receiving information, managing system, controlling system and monitoring system status.

Preferably, according to the present invention, the preset work items are automatically processed in sequence with respect to the settings set by the work item presetting device.

Preferably, according to the present invention, when the switching device switches to the backup power source then the primary power source is connected to the system main body, the timer actuating device and the preset work items are not actuated nor processed.

According to the present invention, the work item presetting device connected to the system main body and having the timer is used for presetting the preset work items, when the primary power source is unable to supply electric power, the switching device is served to switch to the backup power source, and the timer actuating device is actuated and the preset work items are automatically processed; thus, the backup power source can be used for allowing the system main body to be provided with the uninterrupted power supply, and the corresponding preset work items are enabled to be processed.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective exploded view according to the present invention;

FIG. 2 is a perspective view showing the assembly according to the present invention;

FIG. 3 is a schematic view showing the backup power source being externally connected to the system main body according to one embodiment of the present invention;

FIG. 4 is a block diagram showing the automatic control method according to the present invention; and

FIG. 5 is schematic view showing the assembly disclosed in FIG. 2 being applied in an electronic product.

### DETAILED DESCRIPTION OF THE PREFERRED EMBODIMENT

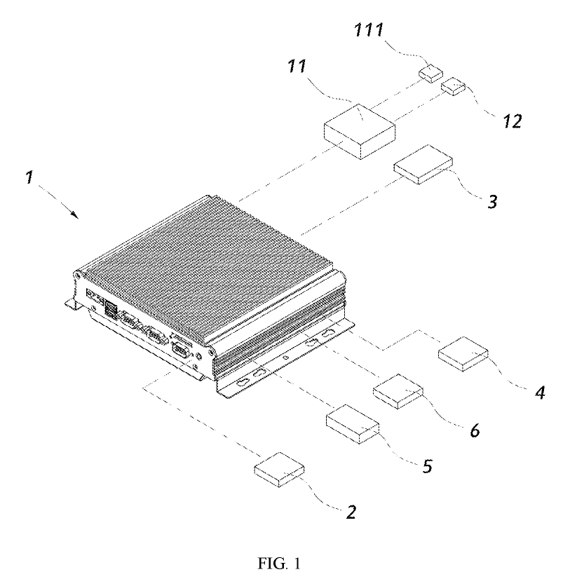

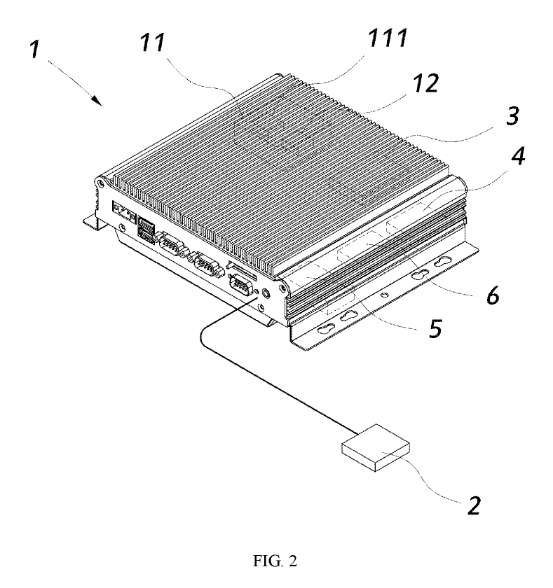

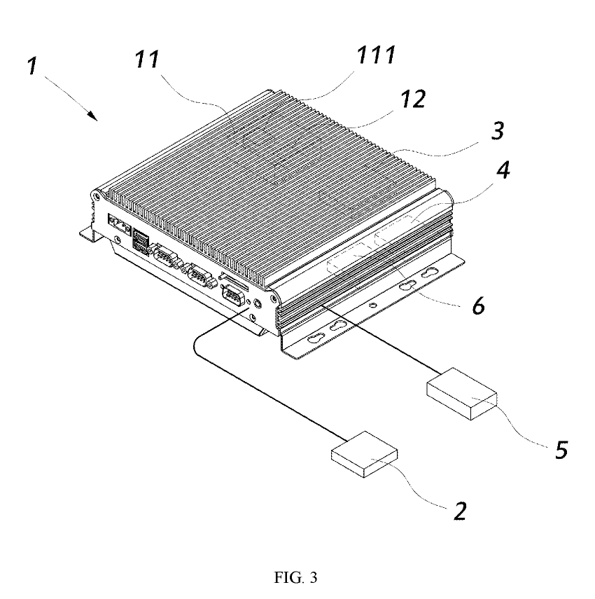

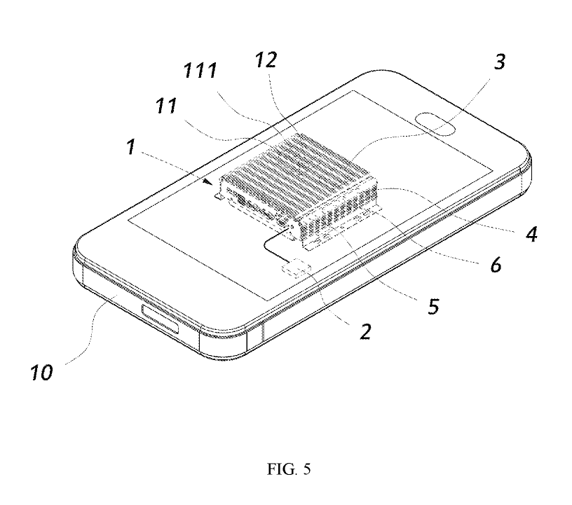

Referring from FIG. 1, FIG. 3, FIG. 3 and FIG. 5, wherein FIG. 1 is a perspective exploded view according to the present invention; FIG. 2 is a perspective view showing the assembly according to the present invention; FIG. 3 is a schematic view showing the backup power source being externally connected to the system main body according to one embodiment of the present invention; and FIG. 5 is schematic view showing the assembly disclosed in FIG. 2 being applied in an electronic product. According to one preferred embodiment of the present invention, an automatic control device for intelligent backup power source is provided, which is applied in an electronic product and includes a system main body 1, a primary power source 2, a work item presetting device 11, a determining device 3, a backup power source 5, a switching device 4 and a timer actuating device 6.

The system main body 1 is connected to an electronic product 10, according this embodiment, the electronic product 10 is a mobile phone (as shown in FIG. 5), but what shall be addressed is that the scope of the present invention is not limited to the above-mentioned mobile phone, the electronic product 10 can also be other electronic products such as a tablet computer and a personal computer (PC).

The primary power source 2 is connected to the system main body 1 and served to supply electric power.

The work item presetting device 11 is connected to the system main body 1 and programmed with a plurality of preset work items 12, and the work item presetting device 11 is installed with a timer 111 for arranging the operating time of the plural preset work items 12, according to this embodiment, the preset work items 12 of the work item presetting device 11 include: calculating, managing power, transferring data, receiving data, storing data, operating, turning on, shutting off, transmitting information, receiving information, managing system, controlling system and monitoring system status, but what shall be addressed is that besides the above-mentioned calculating, managing power, transferring data, receiving data, storing data, operating, turning on, shutting off, transmitting information, receiving information, managing system, controlling system and monitoring system status, various present work items 12 are all with the scope of the present invention. In addition, the timer 111 is served to set time for the plural preset work items 12, such as: calculating after three minutes, actuating power management after three minutes, actuating data transferring after five minutes, actuating data receiving after four minutes, actuating data storing after two minutes, operating after one minute and shutting off after one minute; and the preset work items 12 and the operating time thereof are processed in sequence with respect to the settings.

The determining device 3 is connected to the system main body 1 and served to determine and ensure whether the primary power source 2 operates normally.

The backup power source 5 is connected to the system main body 1 and the determining device 3, according to this embodiment, the backup power source 5 is built-in in the system main body 1 (as shown in FIG. 1 and FIG. 2), but what shall be addressed is that the scope of the present invention is not limited to the above-mentioned arrangement, the backup power source 5 can also be externally connected to the system main body 1 (as shown in FIG. 3).

The switching device 4 is connected to the system main body 1 and the backup power source 5, and served to switch to the electric power provided by the backup power source 5 with respect to the primary power source 2 for being supplied to the system main body 1.

The timer actuating device 6 is connected to the system main body 1, the backup power source 5 and the timer 111 of the work item presetting device 11, and served to process the plural preset work items 12 having the operating time thereof being arranged by the work item presetting device 11; in addition, when the switching device 4 switches to the backup power source 5 then the primary power source 2 is connected to the system main body 1, the timer actuating device 6 and the preset work items 12 are not actuated nor processed.

According to the present invention, the work item presetting device 11 is served to preset the plural preset work items 12, so when in use, the determining device 3 is utilized for determining and ensuring whether the primary power source 2 connected to the system main body 1 operates normally, if the primary power source 2 operates normally, a DO NOTHING status is formed; if the primary power source 2 does not operate, the switching device 4 is utilized for switching to the backup power source 5 for supplying the electric power to the system main body 1, and the timer actuating device 6 is actuated for automatically processing and arranging the plural preset work items 12; after the switching device 4 switches to the backup power source 5, if the primary power source 2 is further connected to the system main body 1, the timer actuating device 6 and the preset work items 12 are not actuated nor processed.

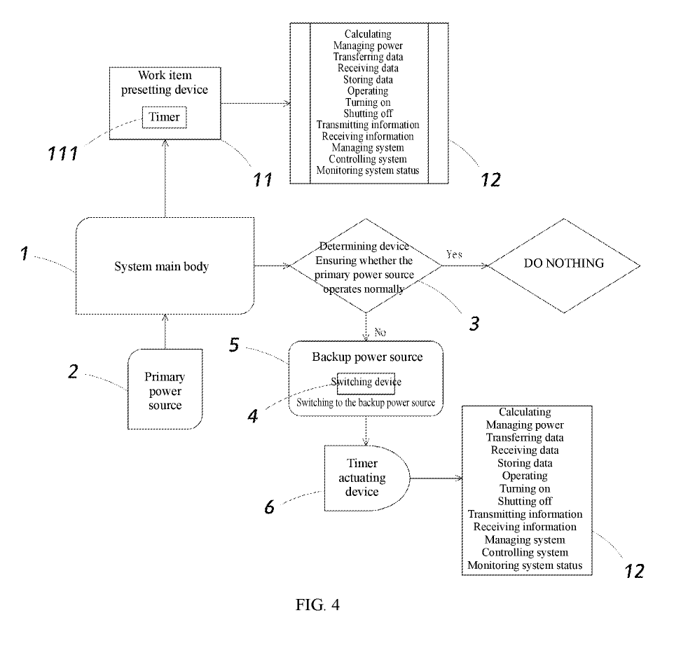

Referring to FIG. 4, which is a block diagram showing the automatic control method according to the present invention. According to one preferred embodiment of the present invention, an automatic control method for intelligent backup power source is provided, and includes the steps of:
(1) connecting the primary power source 2 to the system main body 1;
(2) turning on the system main body 1 and actuating the backup power source 5 connected to the system main body 1;
(3) utilizing the work item presetting device 11 connected to the system main body 1 and having the timer 111 for setting the preset work items 12;
(4) connecting the determining device 4 to the system main body 1, and utilizing the determining device 4 for determining and ensuring whether the primary power source 2 operates normally; if the primary power source 2 is determined to be in a normal operating status, then a DO NOTHING status is formed; if the primary power source 2 does not operate then the switching device 4 is utilized for switching to the backup power source 5; and
(5) actuating the timer actuating device 6 and automatically processing and arranging the preset work items 12.

According to the present invention, the preset work items 12 disclosed in the step (3) includes: calculating, managing power, transferring data, receiving data, storing data, operating, turning on, shutting off, transmitting information, receiving information, managing system, controlling system and monitoring system status; the operating time of the preset work items 12 is in sequence processed with respect to the settings set by the timer 111 of the work item presetting device 11; when the switching device 4 switches to the backup power source 5 then the primary power source 2 is connected to the system main body 1, the timer actuating device 6 and the preset work items 12 are not actuated nor processed.

According to the present invention, the work item presetting device 11 connected to the system main body 1 and having the timer 111 is used for presetting the preset work items 12, when the primary power source 2 is unable to supply electric power, the switching device 4 is served to switch to the backup power source 5, and the timer actuating device 6 is actuated and the preset work items 12 are automatically processed. Thus, the backup power source 5 can be used for allowing the system main body 1 to be provided with the uninterrupted power supply, and the corresponding preset work items 12 are enabled to be processed.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

What is claimed is:

1. An automatic control device for intelligent backup power source, applied in an electronic product and including:
a system main body, connected to the electronic device;
a primary power source, connected to the system main body and served to supply electric power;
a work item presetting device, connected to the system main body and programmed with a plurality of preset work items, wherein the work item presetting device is installed with a timer for arranging the operating time of the plural preset work items;
a determining device, connected to the system main body and served to determine and ensure whether the primary power source operates normally;
a backup power source, connected to the system main body and the determining device;
a switching device, connected to the system main body and the backup power source, and served to switch to the electric power provided by the backup power source with respect to the primary power source for being supplied to the system main body; and
a timer actuating device, connected to the system main body, the backup power source and the timer of the work item presetting device, and served to process the plural preset work items having the operating time thereof being arranged by the work item presetting device.

2. The automatic control device for intelligent backup power source as claimed in claim 1, wherein the backup power source is built-in in the system main body or externally connected to the system main body.

3. The automatic control device for intelligent backup power source as claimed in claim 1, wherein the preset work items of the work item presetting device include: calculating, managing power, transferring data, receiving data, storing data, operating, turning on, shutting off, transmitting information, receiving information, managing system, controlling system and monitoring system status.

4. The automatic control device for intelligent backup power source as claimed in claim 1, wherein the preset work items and the operating time thereof are processed in sequence with respect to the settings.

5. The automatic control device for intelligent backup power source as claimed in claim 1, wherein when the switching device switches to the backup power source then the primary power source is connected to the system main body, the timer actuating device and the preset work items are not actuated nor processed.

6. An automatic control method for intelligent backup power source, including the steps of:
connecting a primary power source to a system main body;
turning on the system main body and actuating a backup power source connected to the system main body;
utilizing a work item presetting device connected to the system main body and having a timer for setting preset work items;
connecting a determining device to the system main body, and utilizing the determining device for determining and ensuring whether the primary power source operates normally; if the primary power source is determined to be in a normal operating status, then a DO NOTHING status is formed; if the primary power source does not operate, then the switching device is utilized for switching to the backup power source; and
actuating a timer actuating device and automatically processing and arranging the preset work items.

7. The automatic control method for intelligent backup power source as claimed in claim 6, wherein the preset work items include: calculating, managing power, transferring data, receiving data, storing data, operating, turning on, shutting off, transmitting information, receiving information, managing system, controlling system and monitoring system status.

8. The automatic control method for intelligent backup power source as claimed in claim 6, wherein the preset work items are automatically processed in sequence with respect to the settings set by the work item presetting device.

9. The automatic control method for intelligent backup power source as claimed in claim 6, wherein when the switching device switches to the backup power source then the primary power source is connected to the system main body, the timer actuating device and the preset work items are not actuated nor processed.
